(19) United States
(12) Patent Application Publication
(10) Pub. No.: US 2012/0064738 A1
(43) Pub. Date: Mar. 15, 2012

(54) Component Interposer

(76) Inventors: Robert C. Shelsky, Nashua, NH (US); Kenneth W. Graham, Plainville, MA (US); Dennis D. Everson, Banks, OR (US)

(21) Appl. No.: 13/135,563

(22) Filed: Jul. 8, 2011

Related U.S. Application Data
(63) Continuation-in-part of application No. 12/495,552, filed on Jun. 30, 2009.
(60) Provisional application No. 61/102,461, filed on Oct. 3, 2008.

(51) Int. Cl. H01R 12/72

(52) U.S. Cl. 439/65

(57) ABSTRACT

A component interposer provides access to signals communicated between an integrated circuit and control circuit board. The component interposer may include a signal circuit board and a socket. The board may include one or more electrical contacts that may be used to sample a signal. The socket may include first and second portions. The first portion may include a surface that contacts with the control circuit board. The first portion may have a first width and first length. The second portion may have a surface that contacts the signal board. The second portion may have a second width and second length. The first length may be smaller than the second length, the first width may be smaller than the second width, or both. The socket may include an overhang that defines a space or void. The socket may include one or more pins for aligning the signal board and the socket. The component interposer may include one or more fasteners. The fasteners may be screws that do not extend into a space or void below the second portion of the socket and above the control circuit board.

### RELATED APPLICATIONS

The present application is a continuation-in-part of U.S. patent application Ser. No. 12/495,552, filed Jun. 30, 2009. U.S. patent application Ser. No. 12/495,552 is an application claiming the benefit under 35 USC Section 119(e) of U.S. Provisional Patent Application Ser. No. 61/102,461, filed Oct. 3, 2008. The present application is based on and claims priority from these applications, the disclosures of which are hereby expressly incorporated herein by reference in their entirety.

### FIELD

The present disclosure relates generally to capturing digital and analog electric signals to test or validate the operation of a target system.

### BACKGROUND

Many computer systems and digital devices include high-speed signal paths and busses. It is necessary to test or validate signal integrity and whether software or firmware is functioning correctly. Testing and validation of a target system may be performed with an oscilloscope, logic analyzer, or bus protocol analyzer. An oscilloscope may be connected to a target system using one or more test probes. A logic analyzer or bus protocol analyzer may be connected to a target system using a pod and test leads. Alternatively, a logic analyzer or bus protocol analyzer may be connected to a target system by inserting a plug into a socket on a circuit board of the target.

A problem with some known solutions is that sampling signals may be intrusive. The process of sampling may itself alter a characteristic of the signal being monitored. In addition, computer systems and digital devices are made small, with individual components placed close together. As a result, there may be no space on a board for dedicated test socket. Further, the pins on integrated circuits (“IC”) are often small and spaced apart by tiny distances. In addition, in many cases pins are omitted and replaced with solder balls and similar connections. The close spacing of components on a board, and the close spacing and small dimensions of IC pins, and the use of solder balls type similar connections in lieu of pins may make it difficult or impossible to attach test leads.

Another problem with some known solutions is that forces that occur during handling of a target system that is connected to a test instrument may cause a test lead or plug to come loose. If these forces dislodge a connection, signals will not be correctly sampled. These forces may also result in physical or electrical damage to a target system component.

### SUMMARY

In one embodiment, a device for non-intrusive sampling of signals to test or validate the operation of a target system is disclosed. The device permits close spacing of components on a board of a target system. The device is able to withstand forces that may occur during handling to prevent damage to the target system.

One embodiment is directed to a component interposer that includes a signal board and a socket. The signal board may include one or more electrical contacts that may be used to sample a signal. The socket may include first and second portions. The first portion may have a surface that contacts a control circuit board of a target system. The first portion may have a first width and first length. The first portion may have a surface that contacts a signal circuit board. The second portion may have a second width and second length. In one embodiment, the first length may be smaller than the second length. In another embodiment, the first width may be smaller than the second width. The socket may include an overhang that defines a space or void.

In one embodiment, the socket includes one or more pins, each pin extending from the second portion. The pins may be used to align the signal circuit board and socket. In addition, the component interposer may include one or more fasteners. In one embodiment the fasteners may be screws. The screws may pass through apertures in the signal circuit board and engage threads in the second portion of the socket. The fasteners may not extend into a space or void below the second portion of the socket and above the integrated circuit board.

### DESCRIPTION OF THE DRAWINGS

FIG. 1 is a cross-sectional, perspective view of a component interposer that includes a socket according to one embodiment.

FIG. 2 is an exploded cross-sectional perspective view of a component interposer according to another embodiment.

FIG. 3 is a flow chart detailing a method for assembling a component interposer according to one embodiment.

FIG. 4 is a side view of the component interposer of FIG. 1 before assembly.

FIG. 5 is a side view of the component interposer of FIG. 1 after assembly.

FIG. 6 is a side view of the socket of FIG. 1.

FIG. 7 is a side view of a component interposer that includes a socket before assembly according to one embodiment.

FIG. 8 is a side view of the component interposer of FIG. 7 after assembly.

FIG. 9 is a top-side view of the socket of FIG. 7.

FIG. 10 is a side view of the component interposer of FIG. 1, illustrating various heights and widths.

FIG. 11 is a side view of the component interposer of FIG. 7, illustrating various heights and widths.

### DESCRIPTION

In the following detailed description of exemplary embodiments, reference is made to the accompanying drawings, which form a part hereof. In the several figures, like referenced numerals identify like elements. The detailed description and the drawings illustrate exemplary embodiments. Other embodiments may be utilized, and other changes may be made, without departing from the spirit or scope of the subject matter presented here. The following detailed description is therefore not to be taken in a limiting sense, and the scope of the claimed subject matter is defined by the appended claims.

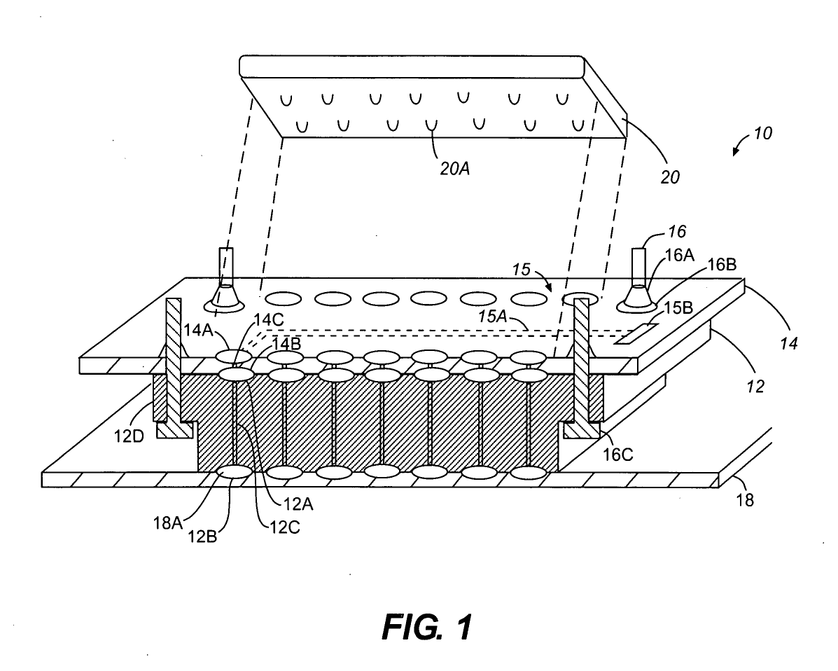

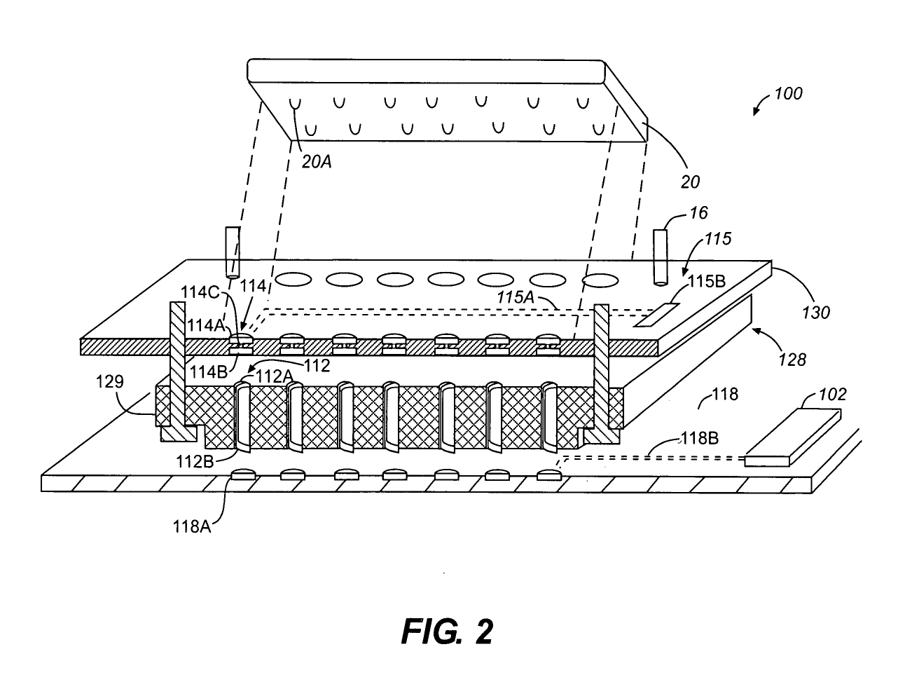

FIG. 1 is a cross-sectional, perspective view of a component interposer or test assembly 10 according to one embodiment. The component interposer 10 may include a socket or connector 12, a test or signal board 14, and one or more fasteners 16. The component interposer 10 is shown with a control board 18 and an integrated circuit 20. The control board 18 may be a circuit board or other part of a target device to be tested. The control board 18 may include two or more electrical contacts 18A. The IC 20 may be a component of the target device, such as a memory IC. The IC 20 may include two or more electrical contacts or solder balls 20A, such as those further described below with reference to FIG. 2. In one embodiment, the control board 18 may include one electrical contact 18A for each electrical contact 20A of the IC 20.

The socket 12 may include one or more electrical contacts 12A for electrical coupling with the signal board 14. In addition, the socket 12 may include one or more electrical contacts 12B for electrical coupling with the control board 18. The socket 12 may include one or more signal lines or paths 12C, each for transmitting signals between a “top” electrical contact 12A and a corresponding “bottom” electrical contact 12B. The electrical contacts and signal lines may be any suitable conductor, such as copper, gold, or aluminum. The socket 12 includes a socket body or housing 12D. The housing 12D may be any material that is non-conducting and able to withstand normal handling forces, such as polyethylene, lightweight polyester composites, polyvinylchloride, polyimide film (Kapton®), polyimide (Cirlex®), or polytetrafluoroethelyne (“PTFE”).

The signal board 14 may include one or more electrical contacts 14A for electrical coupling with the IC 20. In addition, the signal board 14 may include one or more electrical contacts 14B for electrical coupling with the socket 12. The signal board 14 may include one or more signal lines or paths 14C, each for transmitting signals between a “top” electrical contact 14A and a corresponding “bottom” electrical contact 14B. The electrical contacts and signal lines may be any suitable conductor and the signal board may be any suitable non-conducting material.

In one embodiment, the signal board 14 may include one top electrical contact 14A for each electrical contact 20A of the IC 20. In addition, in one embodiment, the signal board 14 may include one bottom electrical contact 14B for each top electrical contact 12A of the socket 12. Further, in one embodiment, the socket 12 may include a one bottom electrical contact 12B for each electrical contact 18A of the control board 18 provided for connecting to the contacts 20A of IC 20.

Pairs of corresponding electrical contacts may be depicted as single element in the figures because after processing or soldering the connections, a pair of connections may be fused into a single connection. For example, a pair of electrical contacts 12A and 14B and a pair of electrical contacts 12B and 18A may be depicted as single element in the figures.

Pairs of electrical contacts 12B and 18A, and 12A and 14B, may not be separate and discrete features or components. For example, a pair of electrical contacts 12B and 18A may, in one embodiment, be a single electrical contact that connects the socket 12 to the control board 18. Alternatively, a pair of electrical contacts, e.g., 12B and 18A may be solder bumps, solder balls, or pads that form an electrical contact by physical contact only. In yet another alternative, a pair of electrical contacts may be solder balls and cups configured to make positive electrical contacts to the solder balls by physical contact only.

Signal board 14 may further include one or more adjunct signal lines 15. Each signal line may include an adjunct signal trace 15A and an adjunct pad 15B. In one embodiment, each signal line 15 may be electrically coupled with an electrical contact of the signal board, i.e., the electrical contacts 14A, 14B and associated signal path 14C. The adjunct pad 15B may be positioned separate from an array of electrical contacts 14A or 14B and may be near the periphery or an edge of signal board 14. For the purposes of this application, the phrases “positioned separate” and “near an edge of signal board” when used to describe the location of an adjunct pad 15B means that the adjunct pad 15B is not positioned under the package of integrated circuit 20 and is accessible. In other words, a reference to an adjunct pad 15B positioned near an edge of signal board means that the pad is not located between the IC 20 and the signal board 14. Assembled, adjunct pads 15B of test assembly 10 may be exposed or accessible, allowing contact with a probe as may be used with a logic analyzer to access each discrete signal of integrated circuit 20.

As mentioned, the component interposer 10 may include one or more fasteners 16. In one embodiment, the fastener 16 may be a pin. The fastener 16 may be assembled to component interposer 10 such that it passes through an aperture in the socket body 12D and also passes through an aperture in the signal board 14. Each fastener 16 may have a separate fastener portion 16A. Fastener 16 may have a proximal end and a distal end. Fastener 16 may include a head 16C at the proximal end. Fastener 16 may be retained in the component interposer 10 by the fastener portion 16A.

The fastener portion 16A may be a solder joint between fastener 16 and a pad 16B on signal board 14. The fastener portion 16A may positively retain fastener 16 in position. Fastener 16 may limit movement of signal board 14 and socket 12 in relation to each other. While fastener 16 is shown as a pin with solder joint 16A in FIG. 1, any retention means which limits movement between socket 12 and signal board 14 is within the scope of this disclosure.

In one embodiment, the fastener 16 may be an extension of socket body 12D and may be formed from the body material of socket 12. On assembling signal board 14 to socket 12, the part of socket body 12D forming pin 16 may protrude through signal board 14. Fastener 16 may be a thermoplastic or other moldable material. The assembling of the component interposer 10 may include an operation of melting and reforming a portion of the fastener 16 to retain the signal board 14 and prevent its movement or disassembly from the socket 12.

Alternatively, the fastener 16 may be a rivet or other retainer that passes through the socket 12 and the signal board 14 on assembly. A portion of the fastener 16 may then be “upset” or deformed to form a head or retaining portion.

In another alternative, the fastener 16 may be threaded and the fastener portion 16A may be a nut screwed onto fastener 16 to hold signal board 14 in place.

Alternatively, fastener 16 may be unthreaded and a fastener portion 16A may comprise a radial retaining ring, push-on nut or self-locking ring that is pressed over fastener 16 to abut signal board 14.

The signal board 14 may further include or be coupled with a cable or flex circuit. The cable or flex circuit may carry signals from the integrated circuit 20 to a test instrument. The cable or flex circuit may be incorporated into assembly 10 so that assembly 10 provides strain relief on the cable or flex circuit.

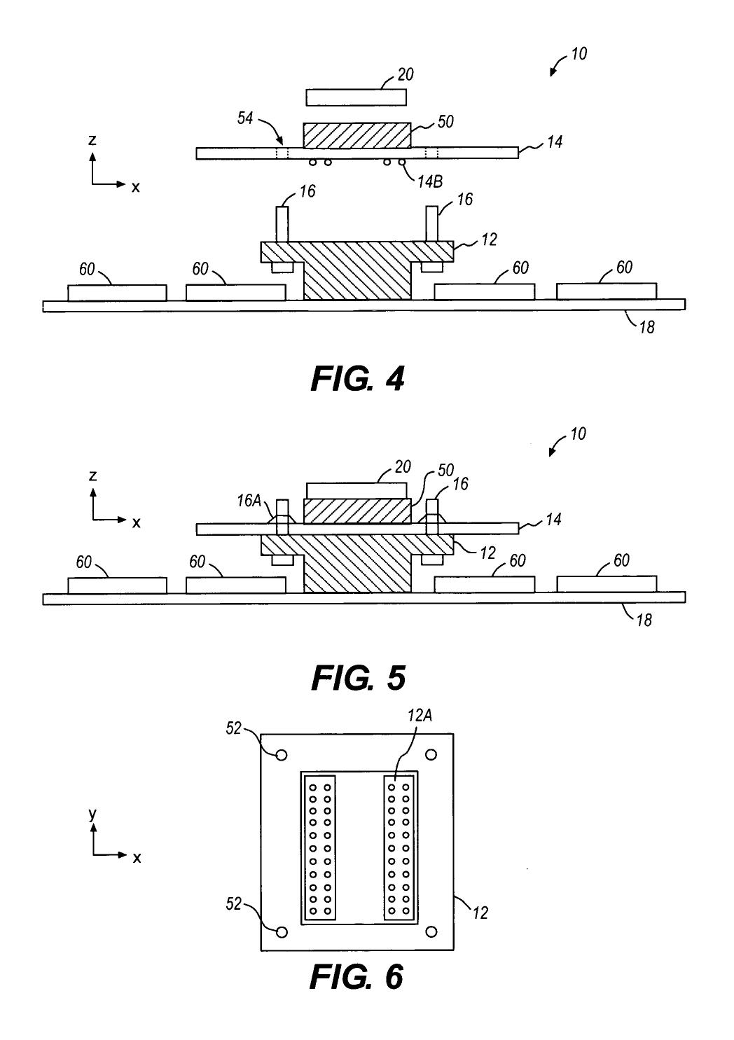

FIGS. 4-6 and 10 are alternative views of the component interposer 10 of FIG. 1. FIGS. 4 and 5 are side views of the component interposer 10. FIG. 4 shows the signal board 14 and IC 20 before assembly. FIG. 5 shows the signal board 14 and IC 20 after assembly. FIG. 6 is a top-side view of the socket 12. The component interposer 10 shown in these figures includes an optional socket 50 that may be mounted on the signal board 14. The socket 50 may be used in lieu of bonding the IC 20 directly to the signal board 14. An advantage of using the socket 50 is that the IC 20 may be easily attached or removed from the control board 18.

Individual components in computer systems and digital devices may be placed close together on circuit boards. FIGS. 4-5 and 10 show ICs 60 mounted on the control board 18. As may be seen from these figures, the ICs 60 may be mounted near the component interposer 10. As one example of closely-spaced components on an IC, eight or more memory ICs may be mounted adjacently on a single in-line memory module (“SIMM”) or a dual in-line memory module (“DIMM”). In one embodiment, the control board 18 may be a SIMM, DIMM, or other similar memory module.

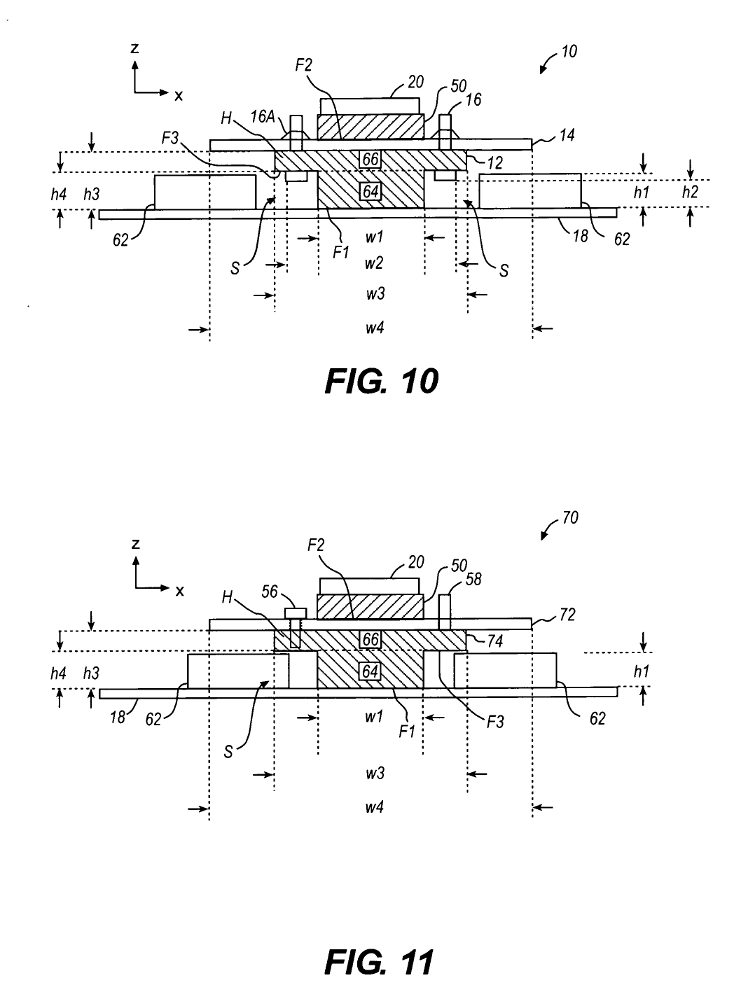

FIG. 10, like FIG. 5, is a side view of the component interposer 10, showing the signal board 14 and IC 20 after assembly. Two ICs 62 are mounted on the control board 18 shown in FIG. 10. The ICs 62 have may have higher profile than the ICs 60. FIG. 10 illustrates various heights and widths of the socket 12, fastener 16, and signal board 14 with respect to the control board 18. As shown in FIG. 10, the socket 12 may include a first portion 64 and a second portion 66. The first portion 64 of the socket 12 may have a width w1 that extends from the control board 18 to a height h4, where the second portion begins. The second portion 66 may have a width w3 that begins at the height of h4 above the control board 18 (when installed) or the surface of the first portion 64 that contacts the control board 18. The width w3 may be greater than the width w1. In one embodiment, the width w3 may be 9.0 mm and the width w1 may be 5.0 mm. In addition, the height h4 may be 1.275 mm. Alternatively, the widths shown in FIG. 10 (and FIG. 11) may be lengths, and a length w3 may be greater than the length w1. In other words, it is not critical which dimension in an x-y plane (see FIG. 6) that the width dimension refers to. In one embodiment, the component interposer 10 may be rectangular and the dimensions shown in FIG. 10 (and FIG. 11) may depict the interposer 10 from any one of four sides. In addition, both the width w3 may be greater than the width w1, and the length w3 may be greater than the length w1.

In one embodiment, a socket 12, 128, or 74 may have a housing that includes first and second portions 64, 66. The first portion 64 may have a first surface F1 that contacts the control circuit board 18. The first portion 64 has a first dimension, which may be either a first length w1 or a first width w1. The second portion 66 has a second dimension, which may be either a second length w3 or a second width w3. The second dimension is oriented in substantially the same direction as the first dimension, e.g., if the first dimension is a width, the second dimension is also a width. The second dimension is larger than the first dimension. The housing defines an open space S between the second portion and the control circuit board.

In one embodiment, a socket 12, 128, or 74 may have a housing that includes first and second portions 64, 66. The first portion 64 may have a first surface F1 that contacts with a first region of a surface of the control circuit board 18. The first surface has a first area. For example, if the first surface is rectangular, the area of the first surface may be calculated by multiplying the width and the length of the area. If the first surface is circular, the area may be calculated using the radius. The first portion 64 may have one or more first side surfaces having a first height h4. In one alternative, the first height may be h2. The second portion 66 may have a second surface F2 to contact with a surface of the signal circuit board 14, 130, 72. The second surface may have a second area that is larger than the first area. In addition, the second portion 66 may have may have a third surface F3 facing a second region of the surface of the control circuit board 18, as well as one or more second side surfaces. The housing defines a void S adjacent to a first side surface that extends the first height from the second region of the surface of the control circuit board 18 to the third surface F3.

In one embodiment, a socket 12, 128, or 74 may have a housing that includes first and second portions 64, 66. The first portion 64 may have a first surface F1 that contacts with the control circuit board 18 and one or more first side surfaces having a first height (h4 or h2). The second portion 66 may have a second surface F2 that contacts with the signal circuit board 14, 130, 72. In addition, the second portion 66 may have one or more second side surfaces, and an overhang H that provides a space S adjacent to a first side surface, extending the first height from the control circuit board 18 to the overhang H.

An advantage of the sockets 12, 128, 72 is that the second portion 66 is elevated above the control board 18, permitting ICs 60, 62 to be mounted in space S close to the component interposer 10. In the example shown in FIG. 5, an IC 60 may be mounted so that part of the IC is located between the second portion 66 and the control board 18. In the example shown in FIG. 10, however, the IC 62 may not be possible to mount the IC so that is located between the second portion 66 and the control board 18. As mentioned, the fastener 16 may include a head 16C at the proximal end. The fastener head 16C may begin at height h2 above the control board 18. In one embodiment, the height h2 may be 0.97 mm. The IC 62 may extend to height h1 above the control board 18. In one embodiment, the height h1 may be 1.0 mm. Because height h1 is greater than height h2, the IC 62 generally may not be mounted so that part of the IC is located between the second portion 66 and the control board 18.

FIG. 2 is an exploded cross-sectional, perspective view of a component interposer 100 according to one embodiment. The component interposer 100 may include some features in common with the component interposer 10. The component interposer 100 may include a socket 128, signal board 130, and one or more fasteners 16. The component interposer 100 is shown with a control board 118 and IC 20.

The control board 118 may be a circuit board or other part of a target device to be tested. The control board 118 may include a processor 102, one or more electrical contacts 118A, and one or more signal lines 118B. One or more of the signal lines 118B may couple the processor 102 with one or more of the electrical contacts 118A.

The socket 128 may include one or more electrical contacts 112. Each electrical contact 112 may include a distal end 112A and a proximal end 112B. The electrical contacts 112 may be a spring-type contact that flexes to exert a normal force when in placed in contact with a mating surface. As shown in FIG. 2, the electrical contacts 112 may be “c” shaped. However, the electrical contacts 112 may be any shape or configuration in which a force is exerted when in placed in contact with a mating surface. The socket 128 may include housing or body 129. The housing 129 may be any material that is non-conducting and able to withstand normal handling forces, such as those described above for housing 12D.

The signal board 130 may include an array of electrical contacts 114. Each electrical contact 114 may include a top electrical contact 114A and a bottom electrical contact 114B. The signal board 130 may include one or more signal lines 114C, each for transmitting signals between a top electrical contact 114A and a bottom electrical contact 114B.

When the component interposer 100 is assembled, the distal end 112A of each electrical contact 112 of the socket 128 may contact an electrical contact 114B of the signal board 130. In addition, the proximal end 112B of each electrical contact 112 of the socket 128 may contact an electrical contact 118A of signal board 18.

The IC 20 may be a ball grid array package (“BGA”) with an array of electrical contacts 20A that defines a two dimensional, planar geometric contact configuration of positions. BGA packaging of this type is well known to those skilled in the art. In one alternative, the IC 20 may be a Fine Ball Grid Array (“FBGA”). Moreover, any configuration which includes solder balls in an array may be employed. Packaging with 78, 86, 96 or any other contact count may be used. The contact array of the ball grid array package may be orthogonal with contacts on 0.8 millimeter centers, but other array configurations may be used.

Each of the sets of one or more electrical contacts 112A and 112B of the socket 128 may be considered an array of contacts conforming to the contact configuration of a ball grid array electrical contacts 20A. Similarly, each of the sets of one or more electrical contacts 114A and 114B of the signal board 130 may be considered an array of contacts conforming to the contact configuration of a ball grid array electrical contacts 20A. In one embodiment, when the component interposer 100 is assembled, each of the electrical contacts 112 may be substantially vertically aligned and orthogonal to the surfaces of the socket 128 that mate with the control board 118 and signal board 130. In addition, each of electrical contacts 114A and 114B, and the signal lines 114C may be substantially vertically aligned and orthogonal to the surfaces of the signal board 130 that mate with the socket 128 and IC 20. As shown in the figures, the signal board 18 may have a uniform thickness. Accordingly, in one embodiment, the electrical contacts 112 may have matched lengths, and the signal lines 114C may have matched lengths.

The signal board 14 may include one or more adjunct signal lines 115. Each adjunct signal line 115 may include an adjunct trace 115A and an adjunct pad 115B. In one embodiment, each signal line 15 may be electrically coupled with an electrical contact of the signal board, i.e., the electrical contacts 114A, 114B and associated signal path 114C. An adjunct pad 115B may be positioned separate from an array of electrical contacts 114A or 114B and may be near the periphery or an edge of the signal board 130. When the component interposer 100 is assembled, adjunct pads 115B may be exposed to allow ^{contact} _{with} ^{a} probe of a logic analyzer or oscilloscope.

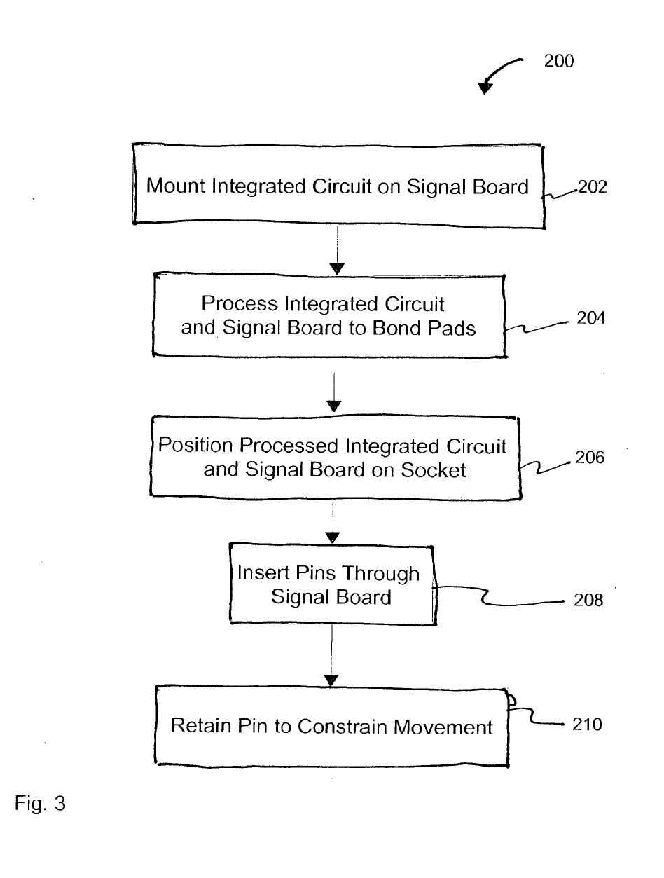

FIG. 3 is a flow chart illustrating steps for assembling an interposer module or test assembly 200. In step 202, ball grid array packaged IC 20 is mounted on signal board, e.g., 14, 72, or 130. The signal board may have top and bottom surfaces, an edge, and an array of pads on the top surface and bottom surface and signal lines disposed in an array pattern connecting corresponding pads on top and bottom surfaces. In step 204, the IC and signal board assembly may be processed to bond the ball grid array IC package to the signal board top surface pads. Processing may include heating the assembly to reflow solder between electrical contacts or pads to provide electrical continuity. In step 206, the processed IC and signal board assembly is positioned on a socket, e.g., 12, 128, or 74, with socket contact array 112. In step 208, fasteners 16 are inserted through the signal board and socket housing. In step 210, fasteners 16 are retained in place so as to constrain movement of the signal board in relation to the socket. Retaining fasteners 16 in place may include soldering fasteners 16, mating threaded portions to fasteners 16, plastically deforming fasteners 16 or pushing on locking nuts or washers.

Alternatively, step 206 may include fasteners 16 as a portion of socket 12. Positioning the signal board assembly on socket 12 may result in fasteners 16 passing through signal board 14. Step 208 is then omitted from this method.

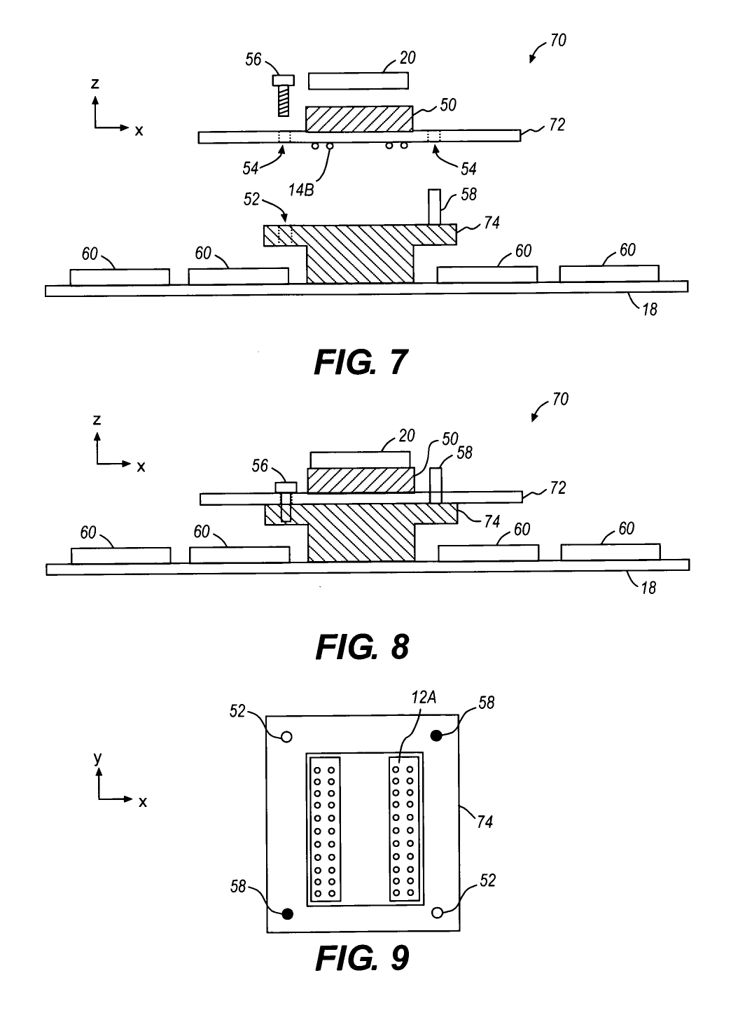

FIGS. 7 and 8 are side views of a component interposer 70 according to one embodiment. FIG. 7 shows the signal board 72 and IC 20 before assembly. FIG. 8 shows the signal board 72 and IC 20 after assembly. FIG. 9 is a top-side view of a socket 74. The component interposer 70 may include an optional socket 50 that may be mounted on the signal board 72. The socket 50 may be used in lieu of bonding the IC 20 directly to the signal board 72.

The component interposer 70 may include a signal board 72 and a socket 74. One or more threaded apertures 52 may be provided in the socket 74. One or more apertures 54 may be provided in the signal board 72. The apertures 54 may or may not be threaded. The component interposer 70 may include one or more fasteners 56. In one embodiment, a fastener 56 may be a screw or a bolt. Fasteners may be made from the materials described above. Fasteners may also be made from metal.

As shown in FIG. 9, in one embodiment, two apertures 52 may be located at diagonally opposite corners of the socket 74. In addition, two pins 58 may be located at the other diagonally opposite corners of the socket 74. Pins may be made from the materials described above for fasteners. Pins may also be made from metal. Further, the signal board 72 may have four apertures 54 at locations corresponding with the locations of the apertures 52 and pins 58 of the socket 74. In a first assembly operation, the component interposer 70 may be assembled by aligning corresponding apertures 54 of the signal board with the pins 58. The signal board 72 may be slid down on the pins 58 until the board comes into contact with the socket 74. An advantage of this embodiment is that once the apertures 54 of the signal board 72 are aligned with the pins 58, the other apertures 54 of the signal board 72 are automatically aligned with the locations of the apertures 52 for receiving screws 56. In a second assembly operation, the screws 56 are inserted in the other apertures 54 and turned so as to engage the threads of respective apertures 52 in the socket 74. A screw 56 may be turned until its head is flush or tight with a “top” surface of the signal board 72.

FIG. 11 is a side view of the component interposer 70, showing the signal board 72 and IC 20 after assembly. Two ICs 62 are mounted on the control board 18 shown in FIG. 11. FIG. 11 illustrates various heights and widths of the socket 74, fastener 56, and signal board 72 with respect to the control board 18. Like the socket 12, the socket 74 may include a first portion 64 and a second portion 66. As described above with respect to socket 12 and shown in FIG. 10, the housing of the socket 74 includes an overhang H that defines a space or void S.

An advantage of the socket 74 is that the second portion 66 is elevated above the control board 18, permitting ICs 60, 62 to be mounted in the space or void S close to the component interposer 70. A further advantage of the component interposer 70 is that a screw 56 does not extend below the second portion 66. In contrast, the fastener 16 may include a head 16C at the proximal end, which may extend below the second portion 66. As shown in FIG. 10, the fastener head 16C may begin at height h2 above the control board 18. Because the fastener head 16C does not extend below the second portion 66, the socket 74 provides greater clearance below the second portion 66 and adjacent to first portion 64 than is provided with the socket 10. In one example, ICs 62 having a height h1 may be mounted so that part of the IC is located between the second portion 66 of socket 74 and the control board 18. In contrast, ICs 62 having a height h1 generally may not be mounted so that part of the IC is located between the second portion 66 and the control board 18.

The described system and assemblies are examples and are not to be used as limitations. The number of pads and electrical contacts may be more or fewer than those shown. The sockets and boards may take on different configurations and shapes. Any suitable configuration or combination of components presented, or equivalents to them that perform a similar function, may also be used.

In one embodiment, the test assembly may be mated to a circuit board with additional components. In one embodiment, the circuit board may be a motherboard for a computer.

The phrase “electrical contact” may include a soldered connection or a non-soldered connection between two electrically conducting faces in electrical contact. A plurality of electrical contacts may form a planar array or contact configuration specific to an integrated circuit packaging system, such as a ball grid array. An electrical contact of an array may be referenced to as a single contact while still remaining a component in an array or matrix of electrical contacts.

The term “corresponding” or “corresponding in position” may be used in reference to the position of two contacts, for example, on two sides of a circuit board. As one example, the two contacts are on two parallel surfaces and a line orthogonal to the parallel surfaces that passes through a contact will also pass through the corresponding contact. Similarly, for a first array with a contact configuration defining the position of each contact, a second array disposed in the same contact configuration and corresponding in position to the first array on a parallel surface, orthogonal lines through each contact of the first array will pass through each corresponding contact of the second array.

Accordingly, the foregoing embodiments are illustrative, and no single feature or element, or combination thereof, is essential to all possible combinations that may be claimed in this or a later application. Each claim defines an invention disclosed in the foregoing disclosure, but any one claim does not necessarily encompass all features or combinations that may be claimed. Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

In this description, references may be made to “one embodiment” or “an embodiment.” These references mean that a particular feature, structure, or characteristic described in connection with the embodiment is included in at least one embodiment of the claimed inventions. Thus, the phrases “in one embodiment” or “an embodiment” in various places are not necessarily all referring to the same embodiment. Furthermore, particular features, structures, or characteristics may be combined in one or more embodiments.

Although embodiments have been described in some detail for purposes of clarity of understanding, it will be apparent that certain changes and modifications may be practiced within the scope of the appended claims. Accordingly, the described embodiments are to be considered as illustrative and not restrictive, and the claimed inventions are not to be limited to the details given herein, but may be modified within the scope and equivalents of the appended claims. Further, the terms and expressions which have been employed in the foregoing specification are used as terms of description and not of limitation, and there is no intention in the use of such terms and expressions to exclude equivalents of the features shown and described or portions thereof, it being recognized that the scope of the inventions are defined and limited only by the claims which follow.

1. A socket for receiving and retaining a signal circuit board, and electrically coupling the signal circuit board with a control circuit board, comprising:
a housing having first and second portions:
the first portion having a first surface to contact with the control circuit board, the first portion having a first dimension, wherein the first dimension is one of a first length and a first width;
the second portion having a second dimension, wherein the second dimension is one of a second length and a second width and is oriented in substantially the same direction as the first dimension;
wherein the second dimension is larger than the first dimension, and the housing defines an open space between the second portion and the control circuit board.

2. The socket of claim 1, further comprising one or more pins, each pin extending from the second portion.

3. The socket of claim 1, further comprising one or more threaded apertures to receive respective screws.

4. A socket for receiving and retaining a signal circuit board, and electrically coupling the signal circuit board with a control circuit board, comprising:
a housing having first and second portions:
the first portion having a first surface to contact with a first region of a surface of the control circuit board, the first surface having a first area, and one or more first side surfaces having a first height; and
the second portion having a second surface to contact with a surface of the signal circuit board, the second surface having a second area that is larger than the first area, a third surface facing a second region of the surface of the control circuit board, and one or more second side surfaces;
wherein the housing defines a void adjacent to a first side surface that extends the first height from the second region of the surface of the control circuit board to the third surface.

5. The socket of claim 1, further comprising one or more pins, each pin extending from the second portion.

6. The socket of claim 1, further comprising one or more threaded apertures to receive respective screws.

7. A socket for receiving and retaining a signal circuit board, and electrically coupling the signal circuit board with a control circuit board, comprising:
a housing having first and second portions:
the first portion having a first surface to contact with the control circuit board and one or more first side surfaces having a first height; and
the second portion having a second surface to contact with the signal circuit board, one or more second side surfaces, and an overhang that provides a space adjacent to a first side surface, extending the first height from the control circuit board to the overhang.

8. The socket of claim 1, further comprising one or more pins, each pin extending from the second portion.

9. The socket of claim 1, further comprising one or more threaded apertures to receive respective screws.
